(19) United States
(12) Patent Application Publication
(10) Pub. No.: US 2009/0130385 A1
(43) Pub. Date: May 21, 2009

(54) Donor substrate and manufacturing method of display device using the same

(75) Inventors: Joo-Hyeon Lee, Yongin-si (KR); Chang-Woong Chu, Suwon-si (KR); Jin-Koo Chung, Suwon-si (KR); Jae-Kook Ha, Yongin-si (KR)

Correspondence Address: Haynes and Boone, LLP;IP Section, 2323 Victory Avenue, SUITE 700, Dallas, TX, 75219, US

(73) Assignee: Samsung Electronics Co,. Ltd.

(21) Appl. No.: 12/008,157

(22) Filed: Jan. 8, 2008

(30) Foreign Application Priority Data
Nov. 21, 2007 (KR) 10-2007-0119271

(51) Int. Cl. B05D 5/12; B32B 3/10

(52) U.S. Cl. 428/138; 427/67

(57) ABSTRACT

A method of manufacturing a display device includes preparing an acceptor substrate, preparing a donor substrate having an organic layer; aligning and combining the acceptor substrate and the donor substrate, and keeping a temperature difference between the acceptor substrate and the donor substrate to transfer the organic layer to the acceptor substrate. Thus, the present invention provides a display device that can simplify a process and decrease a consumption rate of an organic material.

This application claims priority to Korean Patent Application No. 10-2007-0119271, filed on Nov. 21, 2007 the disclosure of which is hereby incorporated herein by reference in its entirety for all purposes.

### BACKGROUND OF THE INVENTION

(a) Field of the Invention The present invention relates to a fabricating method of a display device using a donor substrate, and the donor substrate.

(b) Description of the Related Art

Among flat panel displays, an organic light emitting display (“OLED”) has some advantages because it is driven with a low voltage, is thin and light, has a wide viewing angle, has a relatively short response time, etc. The OLED includes a thin film transistor (“TFT”) having a gate electrode, a source electrode and a drain electrode. The OLED also includes a pixel electrode connected to the TFT, a partition wall dividing the pixel electrodes from each other, an organic light emitting member formed on the pixel electrode between the partition walls, and a common electrode formed on the organic light emitting member.

Here, the organic light emitting member made of an organic material includes a light emitting layer emitting at least one color of white, red, green or blue. The organic light emitting member can further include at least one of a hole injection layer, a hole transport layer, an electron transport layer, or an electron injection layer.

The organic light emitting member can be formed by evaporation using a mask, or inkjet printing. Recently, an organic material has been developed that is formed on an entire surface of a substrate and then the opposite side of the surface is irradiated with a laser.

However, the equipment for using a laser is complex and processing time increases. Also, the formation of the organic material on the entire surface can increase the unnecessary consumption of the organic material.

### BRIEF SUMMARY OF THE INVENTION

Embodiments of the present invention provide a method of manufacturing a display device that can introduce simple equipment, and decrease the consumption rate of organic material.

Another aspect of the present invention provides a donor substrate that can be used for the method.

According to an exemplary embodiment of the present invention, a method of manufacturing a display device includes preparing an acceptor substrate, preparing a donor substrate having an organic layer, aligning the acceptor substrate and the donor substrate, and keeping a temperature difference between the acceptor substrate and the donor substrate to transfer the organic layer to the acceptor substrate.

The keeping of the temperature difference includes heating the donor substrate and cooling the acceptor substrate. The preparing of the donor substrate further includes forming a plurality of heat transfer layers on a first insulating substrate, forming a first partition wall having openings on the heat transfer layers and to cover edges of the heat transfer layers, and forming the organic layer on the heat transfer layers in the openings.

The heat transfer layer includes at least one of molybdenum, tungsten, copper, or alloys thereof.

The forming of the organic layer is characterized with dispensing an organic material using a nozzle or an ink jet printing method.

The organic layer includes at least one of an organic light emitting layer, a hole injection layer, a hole transport layer, an electron transport layer, or an electron injection layer.

The forming of the organic layer includes a drying of the dispensed organic material.

The acceptor substrate includes a switching element, a plurality of pixel electrodes electrically connected to the switching element, and a second partition wall dividing the pixel electrodes.

The aligning of the acceptor substrate and the donor substrate are characterized by corresponding and contacting the first partition wall to the associated second partition wall.

The heating of the donor substrate is characterized by keeping the donor substrate in the range of 100′C to 500′C.

The cooling of the acceptor substrate is characterized by keeping the acceptor substrate less than 100′C.

The temperature difference is in the range of 100′C to 500′C.

The transferring of the organic layer is carried out in a vacuum.

According to exemplary embodiments of the present invention, a method of manufacturing a display device includes preparing a first donor substrate including a first organic light emitting layer representing a first color, preparing an acceptor substrate, aligning and combining the first donor substrate and the acceptor substrate, keeping a temperature difference by heating the first donor substrate and cooling the acceptor substrate to transfer the first organic light emitting layer to the acceptor substrate, separating the first donor substrate and the acceptor substrate, preparing a second donor substrate including a second organic light emitting layer representing a second color different from the first color, aligning and combining the second donor substrate and the acceptor substrate, and keeping a temperature difference by heating the second donor substrate and cooling the acceptor substrate to transfer the second organic light emitting layer to the acceptor substrate.

The transferring of the first and the second organic light emitting layer is carried out in a vacuum.

The temperature difference is in the range of 100′C to 500′C.

According to exemplary embodiments of the present invention, a donor substrate includes an insulating substrate, a plurality of heat transfer layers formed on the insulating substrate, a partition wall having an opening to expose a portion of the metal layer, and an organic layer formed in the opening.

The heat transfer layer includes at least one of molybdenum, tungsten, copper, or alloys thereof. The organic layer includes at least one of an organic light emitting layer, a hole injection layer, a hole transport layer, an electron transport layer, or an electron injection layer.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIGS. 1A and 1B are systematic views illustrating briefly a manufacturing method of a display device according to an exemplary embodiment of the present invention;

FIGS. 2A to 2D illustrate a method of manufacturing a donor substrate such as the donor substrate of FIG. 1 according to an exemplary embodiment of the present invention;

FIG. 3 is a sectional view illustrating an acceptor substrate such as the acceptor substrate of FIG. 1 according to an exemplary embodiment of the present invention;

FIG. 4 is an enlarged detail view of the portion encircled by the dashed line “A” of FIG. 3; and,

FIGS. 5A to 5I illustrate a method of manufacturing a display device according to an exemplary embodiment of the present invention.

Use of the same reference symbols in different figures indicates similar or identical items, and duplicated explanation of the same reference symbols will be skipped.

### DETAILED DESCRIPTION OF THE INVENTION

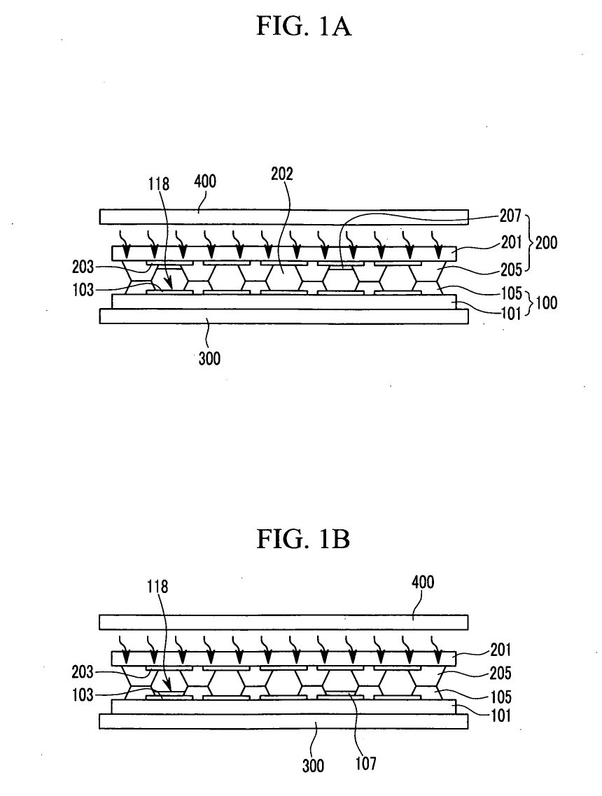

FIGS. 1A and 1B are systematic views illustrating a manufacturing method of a display device according to an exemplary embodiment of the present invention. Referring to FIG. 1A, an acceptor substrate 100 includes a first insulating substrate 101, a plurality of pixel electrodes 103, and a first partition wall 105. The pixel electrodes 103 are formed on the first insulating substrate 101. The first partition wall 105 is formed between the pixel electrodes 103 to cover edges of the pixel electrodes 103 and insulates the pixel electrodes from one another. The first partition wall 105 has a plurality of openings 118 to expose portions of the pixel electrodes 103. A donor substrate 200 includes a second insulating substrate 201, a plurality of metal layers 203, a second partition wall 205, and organic layers 207. The metal layers 203 are formed on the second insulating substrate 201, and the second partition wall 205 is formed between the metal layers 203 to cover edges of the metal layers 203 and electrically separate the metal layers 203 from one another. The second partition wall 205 has a plurality of openings 202 to expose portions of the metal layers 203. The organic layers 207 are formed on the metal layers 203 in the openings 118.

The first insulating substrate 101 and the second insulating substrate 201 can be formed of the same material.

The acceptor substrate 100 and the donor substrate 200 are aligned to contact the first partition wall 105 and the second partition wall 205. The partition walls 105 and 205 keep the gap between both substrates 100 and 200 persistent. The gap between substrates 100 and 200 can be adapted by controlling the height of the partition walls 105 and 205.

The donor substrate 200 is kept at a temperature using a heater 400 in a vacuum where the organic layer 207 can be evaporated. The temperature of the donor substrate depends on the composition of organic layer 207. In one embodiment, the donor substrate 200 can be kept between 100′C to 500′C.

The acceptor substrate 100 is kept at a temperature using a cooler 300 where the organic layer 207 can be sublimated to a solid. The cooling temperature of the acceptor substrate 100 can be adapted to the material type of the organic layer 207. In one embodiment, the acceptor substrate 100 can be kept at less than 100′C.

The metal layer 203 functions to transfer heat efficiently to the organic layer 207.

Referring to FIG. 1B, the organic layer 207 is sublimated to the associated pixel electrode 103 by a temperature difference between the acceptor substrate 100 and the donor substrate 200 to form an organic light emitting member 107. The temperature difference of the two substrates 100 and 200 can be adjusted to the material type of the organic layer 207. In one embodiment, the temperature difference can be kept in the range of 100′c to 500′C. The thickness of the transferred organic light emitting member 107 depends on the thickness of the organic layer 207.

After transferring the organic layer 207 to the acceptor substrate 100, the acceptor substrate 100 can be further heated for improving a life span and reliability of the organic light emitting member 107.

According to the present invention, the amount of organic material used can be decreased by forming the organic layer 207 in a predetermined portion of the donor substrate 200 corresponding to a transferring area. Also, equipment such as the heater and the cooler used during the transfer process is relatively simple and inexpensive.

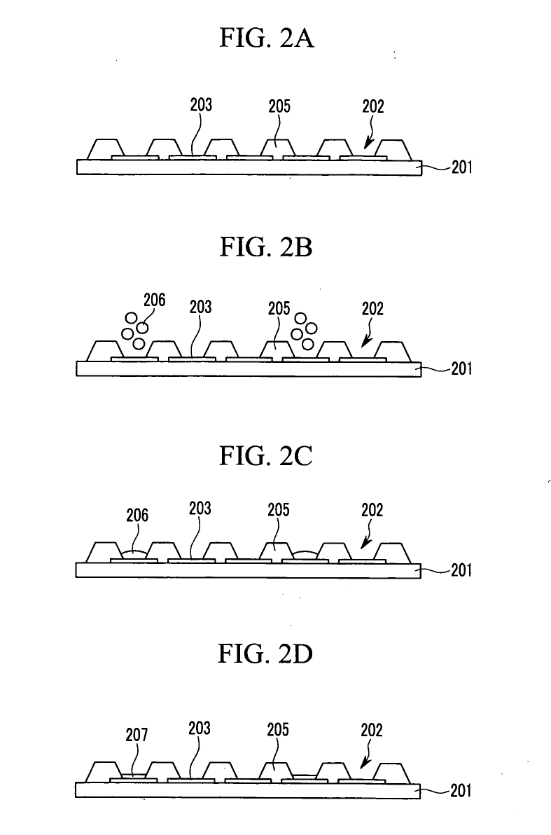

FIGS. 2A to 2D illustrate a method of manufacturing a donor substrate such as the donor substrate of FIG. 1 according to an exemplary embodiment of the present invention.

Referring to FIG. 2A, metal layers 203 are formed on an insulating substrate 201, and partition wall 205 is formed between the metal layers 203. The partition wall 205 electrically separates the metal layers 203 from each other and has openings 202. The insulating substrate 201 is a transparent substrate formed of glass or plastic. The metal layer 203 is formed of molybdenum (Mo), tungsten (W), copper (Cu), or alloys thereof and by sputtering or a heat evaporation.

The partition wall 205 can be formed of an organic or inorganic material and be light sensitive.

Referring to FIG. 2B, an organic material 206 is dispensed on the metal layers 203 in the openings 202 using a nozzle or an ink jet printing method. Before distributing the organic material 206, the surface of the partition wall 205 and the metal layers 203 can be given a plasma treatment (not shown). In another embodiment, a screen printing method can be used.

The dispensing amount of the organic material 206 can be adjusted to the thickness of the organic layer 207. In one embodiment, the height of the partition wall 205 can be in the range of 1 um to 5 um. When the height is less than 1 um, the organic material 206 can flow over the partition wall 205. When the height is greater than 5 um, the gap between the acceptor substrate 100 and the donor substrate 200 of FIGS. 1A and 1B is bigger thereby causing the transferring process time to increase. The height can be modified according to the size of the display device.

Referring to FIGS. 2C and 2D, an organic layer 207 having a flat surface is formed by drying the organic material 206 and removing a solvent from the organic material 206.

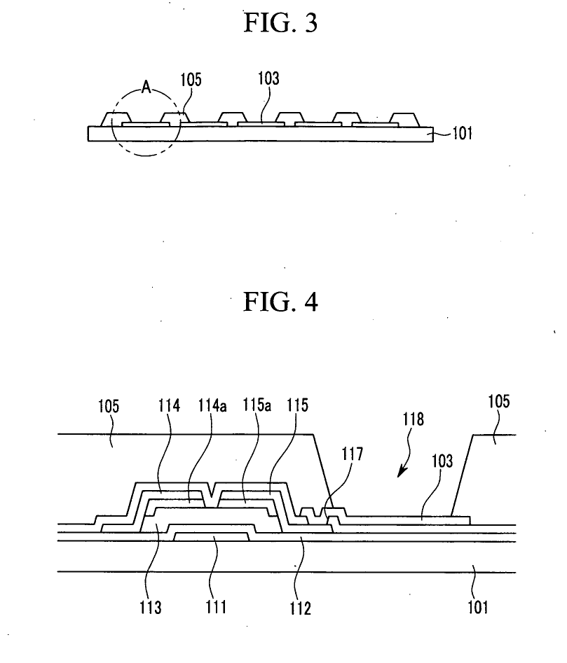

FIG. 3 is a sectional view illustrating an acceptor substrate such as the acceptor substrate of FIGS. 1A and 1B. FIG. 4 is an enlarged detail view of the portion encircled by the dashed line “A” of FIG. 3.

Referring to FIGS. 3 and 4, an acceptor substrate 100 includes a plurality of switching elements. Each switching element includes a gate electrode 111, a semiconductor layer 113, a source electrode 114, a drain electrode 115 and ohmic contacts 114a and 115a. The gate electrode 111 is formed on an insulating substrate 101. An insulating layer 112 is formed on the gate electrode 111 and the insulating substrate 101. The semiconductor layer 113 is formed on the insulating layer 112. The source electrode 114 and the drain electrode 115 are formed on the semiconductor layer 113. Ohmic contacts 114a and 115a are formed between the source electrode 114 and the drain electrode 115 and the semiconductor layer 113 respectively. A passivation layer 116 is formed on the source electrode 114, the drain electrode 115, and the insulating layer 112. The passivation layer 116 has a contact hole 117 to expose a portion of the drain electrode 115. A pixel electrode 103 formed on the passivation layer 116 is electrically connected to the drain electrode 115 through the contact hole 117. A partition wall 105 is formed on the passivation layer 116 to divide the pixel electrodes 103 from each other. The partition wall 105 includes an opening 118 to expose the pixel electrode 103.

The insulating substrate 101 is formed of a transparent substrate such as glass or plastic. The pixel electrode 103 can be formed of indium tin oxide (ITO), indium zinc oxide (IZO), aluminum, calcium, or barium.

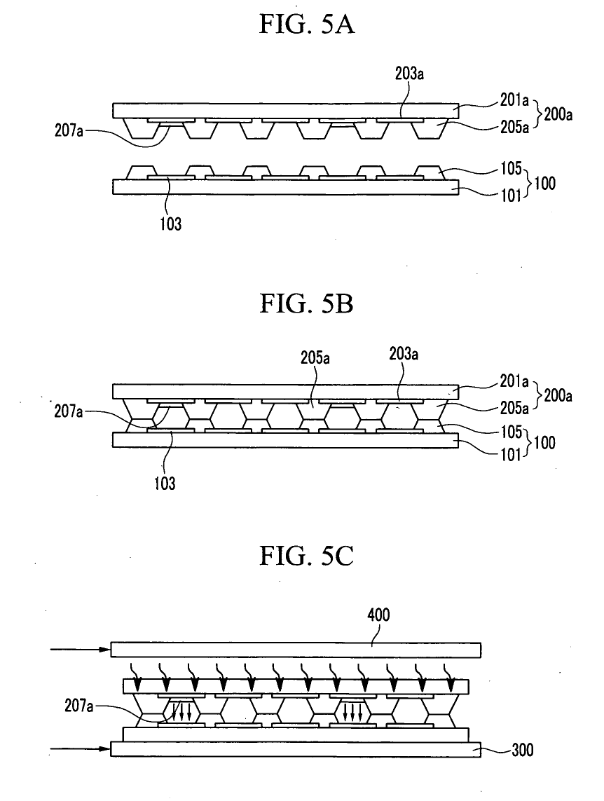

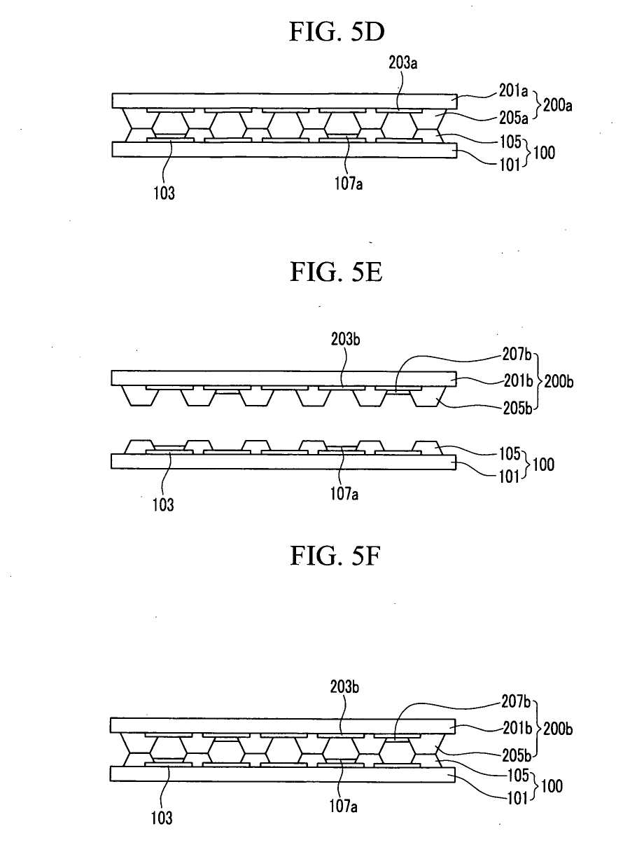

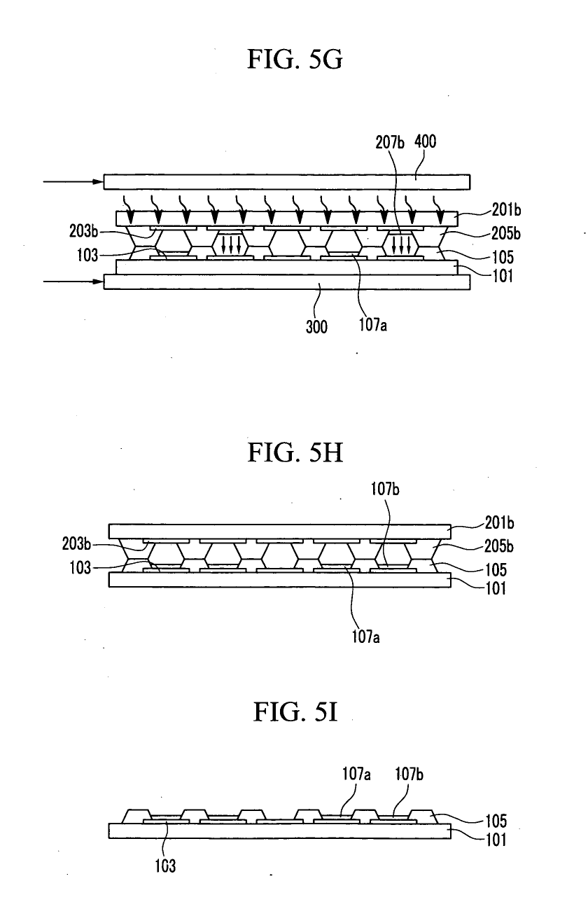

FIGS. 5A to 5I illustrate a method of manufacturing a display device according to an exemplary embodiment of the present invention.

Referring to FIG. 5A, an acceptor substrate 100 having pixel electrodes 103, a partition wall 105, and a plurality of switching elements (not shown) is prepared. A donor substrate 200a having a red organic light emitting material 207a formed on a metal layer 203a is prepared.

Referring to FIG. 5B, the acceptor substrate 100 and the donor substrate 200a are aligned to contact a first partition wall 105 and a corresponding second partition wall 205a.

Referring to FIG. 5C, the donor substrate 200a is kept at a temperature using a heater 400 where the red organic light emitting material 207a can be evaporated. The heat temperature of the donor substrate 200a depends on the material type of the organic light emitting material 207a. In one embodiment, the donor substrate 200a can be kept between 100′C to 500′C.

The acceptor substrate 100 is kept at a temperature using a cooler 300 where the evaporated organic light emitting material can be sublimated to a solid. The cooling temperature of the acceptor substrate 100 can be adapted to the material type of the organic material 207a. In one embodiment, the acceptor substrate 100 can be kept at less than 100′C.

The heater 400 can be a hot plate or lamp type, and the cooler 300 can have a cooling line in which fluid having a low temperature flows.

Referring to FIG. 5D, the red organic light emitting material 207a is sublimated to the associated pixel electrode 103 by a temperature difference between the acceptor substrate 100 and the donor substrate 200a to form a red organic light emitting layer 107a. The temperature difference of the two substrates 100 and 200a can be adjusted to the material type of the red organic light emitting material 207a. In one embodiment, the temperature difference can be kept in the range of 100′c to 500′C. The thickness of the transferred organic light emitting layer 107a depends on the thickness of the red light emitting material 207a.

The donor substrate 200a and the acceptor substrate 100 are separated (not shown).

Referring to FIGS. 5E to 5I, the process is the same as that described in FIGS. 5A to 5D except that a donor substrate 200b has a green organic light emitting material 207b instead of the red organic light emitting material 207a of FIG. 5A. The duplicated explanation will be skipped.

According to the same procedure as illustrated in FIGS. 5A to 5I, a blue organic light emitting layer (not shown) can be formed.

In the prescribed embodiments, the red and the blue organic light emitting layers are formed by using separate donor substrates. However, the red and the blue organic light emitting materials can be formed on the same donor substrate and transferred simultaneously to the acceptor substrate.

Also, any layer of a hole injection layer, a hole transport layer, an electron transport layer, and an electron injection layer can be formed in accordance with the prescribed embodiments.

As described above, the present invention provides a method of fabricating a display device that can simplify a process and decrease a consumption rate of an organic material.

Further, the present invention provides a donor substrate that can be used for the method of fabricating a display device.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of manufacturing a display device comprising:
preparing an acceptor substrate;
preparing a donor substrate having an organic layer;
aligning the acceptor substrate and the donor substrate; and,
keeping a temperature difference between the acceptor substrate and the donor substrate to transfer the organic layer to the acceptor substrate.

2. The method of claim 1, wherein the keeping of the temperature difference comprises heating the donor substrate and cooling the acceptor substrate.

3. The method of claim 2, wherein the preparing of the donor substrate further comprises
forming a plurality of heat transfer layers on the a first insulating substrate;
forming a first partition wall having openings on the heat transfer layers and to cover edges of the heat transfer layers; and,
forming the organic layer on the heat transfer layers in the opening.

4. The method of claim 3, wherein the heat transfer layer includes at least one of molybdenum, tungsten, copper, or alloys thereof.

5. The method of claim 3, wherein the forming of the organic layer is characterized with dispensing an organic material using a nozzle or an ink jet printing method.

6. The method of claim 5, wherein the organic layer includes at least one of an organic light emitting layer, a hole injection layer, a hole transport layer, an electron transport layer, or an electron injection layer.

7. The method of claim 5, wherein the forming of the organic layer comprises a drying of the dispensed organic material.

8. The method of claim 3, wherein the acceptor substrate includes a switching element, a plurality of pixel electrodes electrically connected to the switching element, and a second partition wall dividing the pixel electrodes.

9. The method of claim 8, wherein the aligning and the combining of the acceptor substrate and the donor substrate is characterized with corresponding and contacting the first partition wall to the associated second partition wall.

10. The method of claim 2, wherein the heating of the donor substrate is characterized with keeping the donor substrate in the range of 100′C to 500′C.

11. The method of claim 10, wherein the cooling of the acceptor substrate is characterized with keeping the acceptor substrate less than 100′C.

12. The method of claim 2, wherein the temperature difference is in the range of 100′C to 500′C.

13. The method of claim 2, wherein the transferring of the organic layer is carried out in a vacuum.

14. A method of manufacturing a display device comprising:
preparing a first donor substrate including a first organic light emitting layer representing a first color;
preparing an acceptor substrate;
aligning and combining the first donor substrate and the acceptor substrate;
keeping a first temperature difference by heating the first donor substrate and cooling the acceptor substrate to transfer the first organic light emitting layer to the acceptor substrate;
separating the first donor substrate and the acceptor substrate;
preparing a second donor substrate including a second organic light emitting layer representing a second color different from the first color;
aligning and combining the second donor substrate and the acceptor substrate; and,
keeping a second temperature difference by heating the second donor substrate and cooling the acceptor substrate to transfer the second organic light emitting layer to the acceptor substrate.

15. The method of claim 14, wherein the transferring of the first and the second organic light emitting layer is carried out in a vacuum.

16. The method of claim 14, wherein the first and the second temperature difference are in the range of 100′C to 500′C.

17. A donor substrate, comprising:
an insulating substrate;
a plurality of heat transfer layers formed on the insulating substrate;
a partition wall having an opening to expose a portion of the metal layer; and,
an organic layer formed in the opening.

18. The donor substrate of claim 17, wherein the heat transfer layer includes at least one of molybdenum, tungsten, copper, or alloys thereof.

19. The donor substrate of claim 17, wherein the organic layer includes at least one of an organic light emitting layer, a hole injection layer, a hole transport layer, an electron transport layer, or an electron injection layer.
